(19) United States
(12) Patent Application Publication
(10) Pub. No.: US 2006/0182315 A1
(43) Pub. Date: Aug. 17, 2006

(54) Method and apparatus for encoding/decoding and referencing virtual area image

(75) Inventor: Sang-chang Cha, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/353,135

(22) Filed: Feb. 14, 2006

Related U.S. Application Data
(60) Provisional application No. 60/652,003, filed on Feb. 14, 2005.

(30) Foreign Application Priority Data
Apr. 4, 2005 (KR) 10-2005-0028248

(51) Int. Cl. G06K 9/00

(52) U.S. Cl. 382/107

(57) ABSTRACT

A method and an apparatus for encoding/decoding and referencing a virtual area image are disclosed. A method for encoding and referencing the virtual area image includes generating a base layer frame from an input video signal, restoring a virtual area image in an outside area of the base layer frame through a corresponding image of a reference frame of the base layer frame, adding the restored virtual area image to the base layer frame to generate a virtual area base layer frame, and differentiating the virtual area base layer frame from the video signal to generate an enhanced layer frame.

### CROSS-REFERENCE TO RELATED APPLICATION

This application claims priority from Korean Patent Application No. 10-2005-0028248 filed on Apr. 4, 2005 in the Korean Intellectual Property Office, and U.S. Provisional Patent Application No. 60/652,003 filed on Feb. 14, 2005 in the United States Patent and Trademark Office, the disclosures of which are incorporated herein by reference in their entirety.

### BACKGROUND OF THE INVENTION

1. Field of the Invention

Apparatuses and methods consistent with the present invention relate to encoding and decoding referencing a virtual area image.

2. Description of the Related Art

As information technology including the Internet develops, video communication is increasing, in addition to text and audio communication. Existing text communication does not fully satisfy the various demands of customers, and multimedia services have been created to transmit information such as text, video and music. Multimedia data is large and requires large capacity storage media and a broadband width to be transmitted. A compression coding is used to transmit multimedia data including text, video and audio.

The basic principle in compressing data is to eliminate data redundancy. The redundancy of data comprises spatial redundancy which repeats identical colors or objects in images; temporal redundancy, where neighboring frames in motion pictures lack differences, or identical sounds are repeated; and psycho visual redundancy, which considers the insensitivity of human vision and perception. In conventional video coding, the temporal redundancy is excluded by temporal filtering based on a motion compensation, and the spatial redundancy is excluded by a spatial transformation.

After the redundancy is eliminated from the multimedia data, it is transmitted via a transmission medium. Transmission media have different performance characteristics. Current transmission media include diverse transmission speeds (i.e., high speed communication networks for transmitting data at tens of MB/sec to mobile communication networks having a transmission speed of 384 KB/sec). Under such circumstances, a scalable video coding method may be more suitable for supporting the transmission media at various speeds. Scalable video coding makes it possible to transmit multimedia at a transmission rate corresponding to the transmission environment. The aspect ratio may be changed to 4:3 or 16:9 according to the size or features of an apparatus that generates multimedia.

The scalable video coding cuts out a part of a bit stream already compressed, according to the transmission bit rate, transmission error rate, and system resources in order to adjust the resolution, frame rate and bit rate. The moving picture experts group-21 (MPEG-4) Part 10 is already working on standardizing scalable video coding. Particularly, the standardization is based on multi-layers in order to realize scalability. For example, the multi-layers comprise a base layer, an enhanced layer 1 and an enhanced layer 2. The respective layers may comprise different resolutions (QCIF, CIF and 2CIF) and frame-rates.

Like single layer encoding, multi-layer coding requires a motion vector to exclude temporal redundancy. The motion vector may be acquired from each layer or it may be acquired from one layer and applied to other layers (i.e., up/down sampling). The former method provides a more precise motion vector than the latter method does, but the former method generates overhead. In the former method, it is important to more efficiently exclude redundancy between motion vectors of each layer.

FIG. 1 is an example of a scalable video codec employing a multi-layer structure. A base layer is in the quarter common intermediate format (QCIF) at 15 Hz, and an enhanced layer 1 is in the common intermediate format (CIF) at 30 Hz, and an enhanced layer 2 is in standard definition (SD) at 60 Hz. A CIF 0.5 Mbps stream may be provided by cutting the bit stream from CIF_{—}30 Hz_{—}0.7M to a 0.5 M bit rate. Using the foregoing method, spatial, temporal and SNR scalability can be realized.

As shown in FIG. 1, frames of respective layers having an identical temporal position may comprise similar images. Thus, current layer texture may be predicted by base layer texture, and the difference between the predicted value and the current layer texture may be encoded. “Scalable Video Model 3.0 of ISO/IEC 21000-13 Scalable Video Coding (hereinafter, referred to as “SVM 3.0”) defines the foregoing method as Intra_BL prediction.

SVM 3.0 additionally adopts a method of predicting a current block by using the correlation between base layer blocks corresponding to the current block, as well as adopting inter prediction and directional intra prediction to predict blocks or macro-blocks comprising the current frame in existing H.264. The foregoing method may be referred to as intra BL prediction, and a coding mode which employs the foregoing prediction methods is referred to as intra BL mode.

FIG. 2 is a schematic view of three prediction methods. The three prediction methods comprise intra prediction \textcircled{1} of a certain macro-block 14 of a current frame 11; inter prediction \textcircled{2} using a frame 12 disposed in a different temporal position from the current frame 11; and intra BL prediction \textcircled{3} using texture data of an area 16 of a base layer frame 13 corresponding to the macro-block 14.

The scalable video coding standards employ one of the three prediction methods by macro-block.

However, if the frame rate is different between the layers as shown in FIG. 1, a frame 40 may exist that does not comprise the base layer frame. Also, Intra-BL prediction may be not applicable to the frame 40. The frame 40 is coded by using only information of the corresponding layer (i.e., by using inter prediction and intra prediction only) without using information of the base layer; also, it is inefficient in coding performance.

If a video area provided by frames of the base layer, current layer or upper layer is different due to the size of the display, the upper layer may not refer to video information of the base layer.

FIG. 3 illustrates images of upper and base positions in different sizes while coding the video of the multi-layer structure. As shown therein, the video image is divided into two layers. Base layers 101, 102 and 103 provide images that have a small width. Upper layers 201, 202 and 203 provide images having a larger width than that of the base layers 101, 102 and 103. As shown therein, the upper layers may comprise images which are not included in the video information of the base layers. The upper layers refer to image or video information of the base layers when they are divided into frames to be transmitted. Frame 201 refers to frame 101 (to be generated), the frame 202 refers to the frame 102, and the frame 203 refers to frame 103. The video in FIG. 3 is an object that is shaped like a star and that moves in a leftward direction. Frame 102, referred to by the frame 202, is shaped like a star, a part of which is excluded. The star is disposed on the left side 212 of the frame 202, of the video. The left video information may not refer to the base layer data when it is coded. In frame 103, referred to by frame 203, the star moves in the leftward direction, and more of it is missing relative to frame 102. When the star is disposed on the left side 213 of the frame 203 (the upper layer), it may not refer to the base layer data.

Due to various sizes of the display as shown in FIG. 3, a part of the original video is excluded to generate the video of the base layers, and it is restored to generate the video of the upper layers. Thus, the upper layers may not refer to the video of the base layers for some areas. The upper layers may refer to a frame of a previous upper layer through an inter-mode to compensate the area that is not referred to. The Intra-BL mode is not used, thereby lowering the accuracy of the data. Also, as part of the area does not refer to the video of the base layer, the amount of data to be compressed increases, thereby lowering compression efficiency. Thus, it is necessary to increase the compression rate of layers having images of different sizes.

### SUMMARY OF THE INVENTION

The present invention provides a method and an apparatus for encoding and decoding a video of upper layers by using motion information in a multi-layer structure having images in variable size by layer.

Also, the present invention is to restore images which are not included in a base layer and to enhance compression efficiency.

The above stated aspects as well as other aspects, features and advantages, of the present invention will become clear to those skilled in the art upon review of the following description.

According to an aspect of the present invention, there is provided a method for encoding referencing a virtual area image comprising (a) generating a base layer frame from an input video signal; (b) restoring a virtual area image in an outside of the base layer frame through a corresponding image of a reference frame of the base layer frame; (c) adding the restored virtual area image to the base layer frame to generate a virtual area base layer frame; and (d) differentiating the virtual area base layer frame from the video signal to generate an enhanced layer frame.

According to another aspect of the present invention, (b) comprises determining the virtual area image in the outside of the base layer frame as a motion vector of a block existing in a boundary area of the base layer frame.

According to another aspect of the present invention, the reference frame of (b) is ahead of the base layer frame.

According to another aspect of the present invention, (b) comprises copying motion information which exists in the boundary area of the base layer frame.

According to another aspect of the present invention, (b) comprises generating motion information according to a proportion of motion information of the block in the boundary area of the base layer frame and motion information of a neighboring block.

According to another aspect of the present invention, the enhanced layer frame of (d) comprises an image having a larger area than the image supplied by the base layer frame.

According to another aspect of the present invention, the method further comprises storing the virtual area base layer frame of the base layer frame.

According to an aspect of the present invention, there is provided a method for decoding referencing a virtual area image comprising (a) restoring a base layer frame from a bit stream; (b) restoring a virtual area image in an outside of the restored base layer frame through a corresponding image of a reference frame of the base layer frame; (c) adding the restored virtual area image to the base layer frame to generate a virtual area base layer frame; (d) restoring an enhanced layer frame from the bit stream; and (e) combining the enhanced layer frame and the virtual area base layer frame to generate an image.

According to another aspect of the present invention, (b) comprises determining the virtual area image in the outside of the base layer frame as a motion vector of a block which exists in a boundary area of the base layer frame.

According to another aspect of the present invention, the reference frame of (b) is ahead of the base layer frame.

According to another aspect of the present invention, (b) comprises copying motion information which exists in the boundary area of the base layer frame.

According to another aspect of the present invention, (b) comprises generating motion information according to a proportion of motion information of the block in the boundary area of the base layer frame and motion information of a neighboring block.

According to another aspect of the present invention, the enhanced layer frame of (e) comprises an image having a larger area than the image supplied by the base layer frame.

According to another aspect of the present invention, the method further comprises storing the virtual area base layer frame or the base layer frame.

According to an aspect of the present invention, there is provided an encoder comprising a base layer encoder to generate a base layer frame from an input video signal; and an enhanced layer encoder to generate an enhanced layer frame from the video signal, wherein the base layer encoder restores a virtual area image in an outside of the base layer frame through a corresponding image of a reference frame of the base layer frame and adds the restored virtual area image to the base layer frame to generate a virtual area base layer frame, and the enhanced layer encoder differentiates the virtual area base layer frame from the video signal to generate an enhanced layer frame.

According to another aspect of the present invention, the encoder further comprises a motion estimator to acquire motion information of an image and to determine the virtual area image in the outside of the base layer frame as a motion vector of a block which exists in a boundary area of the base layer frame.

According to another aspect of the present invention, the reference frame is ahead of the base layer frame.

According to another aspect of the present invention, the virtual area frame generator copies motion information which exists in the boundary area of the base layer frame.

According to another aspect of the present invention, the virtual area frame generator generates the motion information according to a proportion of motion information of a block existing in the boundary area of the base layer frame and motion information of a neighboring block.

According to another aspect of the present invention, the enhanced layer frame comprises an image having a larger area than the image supplied by the base layer frame.

According to another aspect of the present invention, the encoder further comprises a frame buffer to store the virtual area base layer frame or the base layer frame therein.

According to an aspect of the present invention, there is provided a decoder comprising a base layer decoder to restore a base layer frame from a bit stream; and an enhanced layer decoder to restore an enhanced layer frame from the bit stream, wherein the base layer decoder comprises a virtual area frame generator to generate a virtual area base layer frame by restoring a virtual area image in an outside of the restored base layer frame through a corresponding image of a reference frame of the base layer frame and by adding the restored image to the base layer frame, and the enhanced layer decoder combines the enhanced layer frame and the virtual area base layer frame to generate an image.

According to another aspect of the present invention, the decoder further comprises a motion estimator to acquire motion information of an image and to determine the virtual area image in the outside of the base layer frame as a motion vector of a block which exists in a boundary area of the base layer frame.

According to another aspect of the present invention, the reference frame is ahead of the base layer frame.

According to another aspect of the present invention, the virtual area frame generator copies motion information which exists in the boundary area of the base layer frame.

According to another aspect of the present invention, the virtual area frame generator generates the motion information according to a proportion of motion information of a block existing in the boundary area of the base layer frame and motion information of a neighboring block.

According to another aspect of the present invention, the enhanced layer frame comprises an image having a larger area than the image supplied by the base layer frame.

According to another aspect of the present invention, the decoder further comprises a frame buffer to store the virtual area base layer frame or the base layer frame therein.

### BRIEF DESCRIPTION OF THE DRAWINGS

The above and other features and advantages of the present invention will become more apparent by describing in detail exemplary embodiments thereof with reference to the attached drawings in which:

FIG. 1 is an example of scalable video coding/decoding which uses a multi-layer structure;

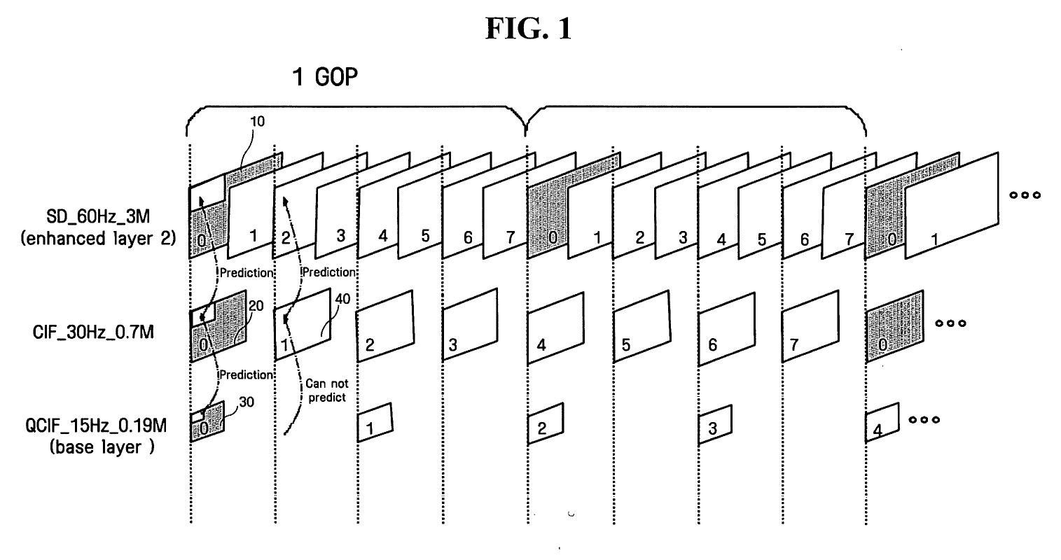

FIG. 2 is a schematic view of a prediction method of a block or macro-block;

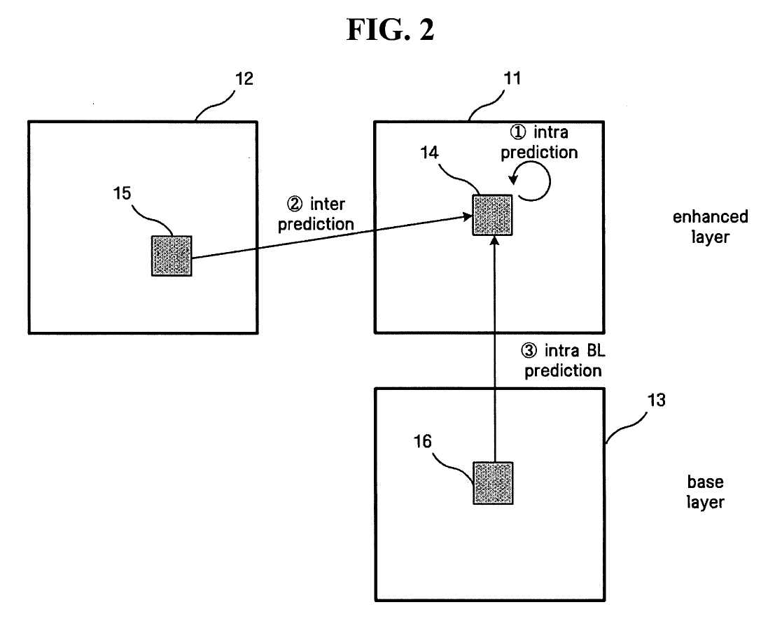

FIG. 3 illustrates upper and base images of different sizes while coding a video in a multi-layer structure;

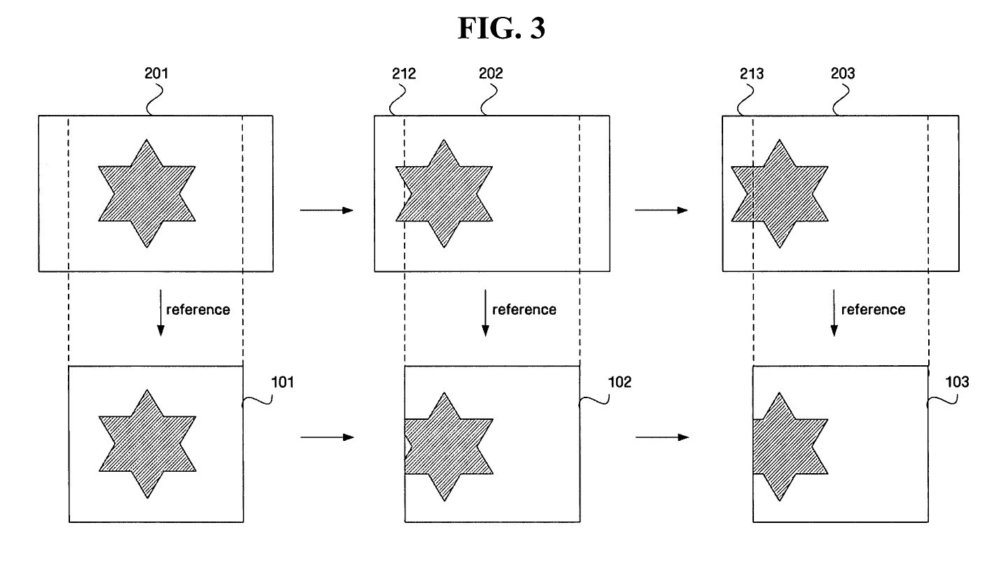

FIG. 4 is an example of coding data which does not exist in video information of a base layer with reference to information of a previous frame while coding a video of a upper layer according to an embodiment of the present invention;

FIG. 5 is an example of generating a virtual area by copying motion information according to an embodiment of the present invention;

FIG. 6 is an example of generating a virtual area by proportionally calculating motion information according to an embodiment of the present invention;

FIG. 7 is an example of generating a virtual area frame while it is encoded according to an embodiment of the present invention;

FIG. 8 is an example of generating a virtual area frame by using motion information according to an embodiment of the present invention;

FIG. 9 is an example of decoding base and upper layers according to an embodiment of the present invention;

FIG. 10 is an example of a configuration of a video encoder according to an embodiment of the present invention;

FIG. 11 is an example of a configuration of a video decoder according to an embodiment of the present invention;

FIG. 12 a flowchart of encoding a video according to an embodiment of the present invention; and

FIG. 13 is a flowchart of decoding a video according to an embodiment of the present invention.

### DETAILED DESCRIPTION OF THE PREFERRED EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

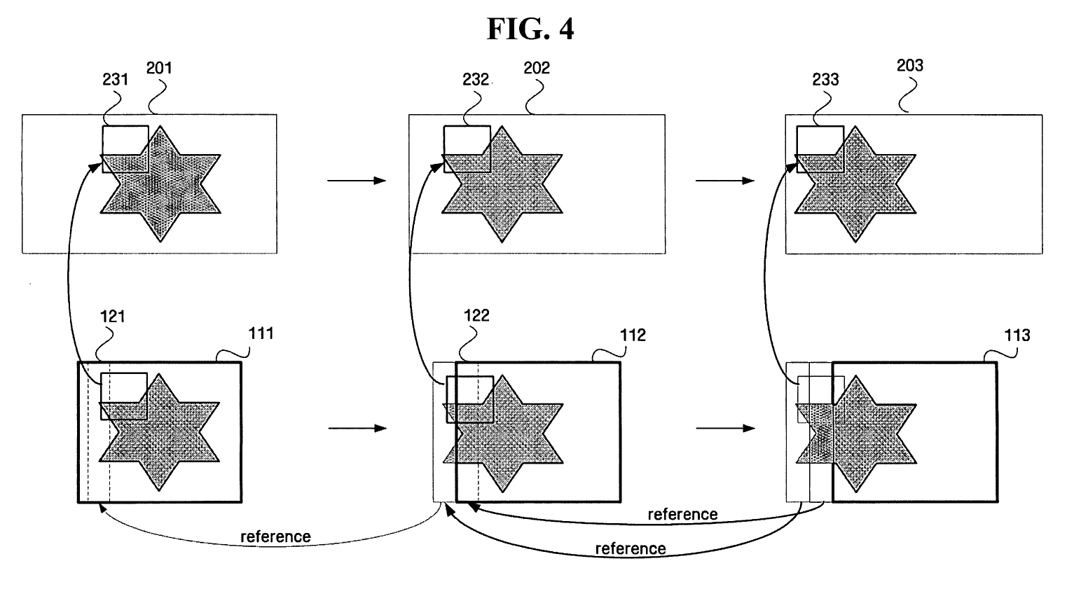

FIG. 4 is an example of coding data that does not exist in video information of a base layer with reference to information of a previous frame while coding a video of an upper layer. Upper layer frames 201, 202 and 203 refer to base layer frames 111, 112 and 113, respectively. A part 231 that is included in a video of the frame 201 exists in a video of the base layer frame 111. Thus, the part 231 may be generated by referring to base information.

A part 232 that is included in a video of the frame 202 exists in the base layer frame 112 wherein a part thereof is excluded. A user may recognize which area of the previous frame is referred to through motion information of the frame 112. As the motion information in a boundary area of the frame is directed to the inside of a screen, a virtual area is generated by using the motion information. The virtual area may be generated by copying the motion information from neighboring areas or by extrapolation. Also, the motion information is used to generate corresponding areas from a restored image of the previous frame. The area 121 of the frame 111 is externally disposed, and a frame added with image information thereof may be generated. When the frame 202 of the upper layer is restored from a frame having the virtual area, video information of the area 232 may be referred to by the base layer.

The video information of the area 233 is not included in the base frame 113. However, the previous frame 112 comprises the corresponding image information. Also, the virtual area of the previous frame 112 comprises image information, thereby generating a new virtual base frame therefrom to be referred to. The areas 231, 232 and 233 of the upper layer frames 201, 202 and 203, respectively, exist in the virtual area and may be coded with a reference to the virtual area even if a part or the entire image is outside of the frame.

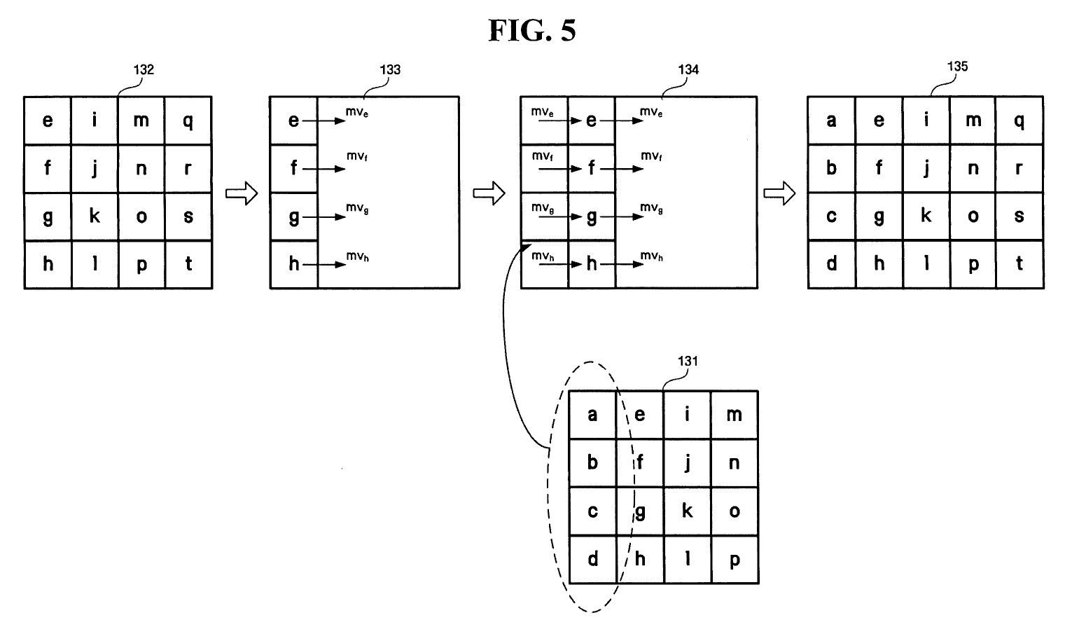

FIG. 5 is an example of generating the virtual area by copying the motion information according to an embodiment of the present invention. The frame 132 is divided into 16 areas. Each area may comprise a macro-block or a group of macro-blocks. A motion vector of e, f, g and h disposed in a left boundary area of the frame 132 is the same as that of the frame 133. Motion vectors mvₑ, mv_{f}, mv_{g} and mvₕ respectively of e, f, g and h are directed to the center of the frame. That is, the image moves to the outside, compared to that in the previous frame. The motion vectors are shown in relation to reference frames, and they indicate where the macro-block is disposed. Thus, the direction of the motion vectors is opposite to the direction that images or objects move according to the time axis when the previous frame is designated as the reference frame. The direction (arrow) of the motion vectors in FIG. 5 indicates a position of the corresponding macro-block in the previous frame, as in the reference frame.

That is, a camera is panning or the object is moving. Then, the video information that does not exist in the boundary area may be restored with reference to the previous frame. The virtual area is generated on the left side of e, f, g and h, and the motion vector of the area copies the motion vectors mvₑ, mv_{f}, mv_{g} and mvₕ thereof and refers to the information of the virtual area from the previous frame. The previous frame is the frame 131, the information of the frame 131 and that of the frame 134 are combined to generate a restoration frame 135 of a new virtual area. Thus, a new frame adding a, b, c and d in a left side thereof is generated and the upper frame referring to the frame 132 refers to the frame 135 to be coded.

If the motion information of the frame 132 is directed to a right side, the motion information of the boundary area is copied and the previous frame is referred to generate a new virtual area. Alternatively, the new virtual area may be generated by extrapolation, without copying the motion information.

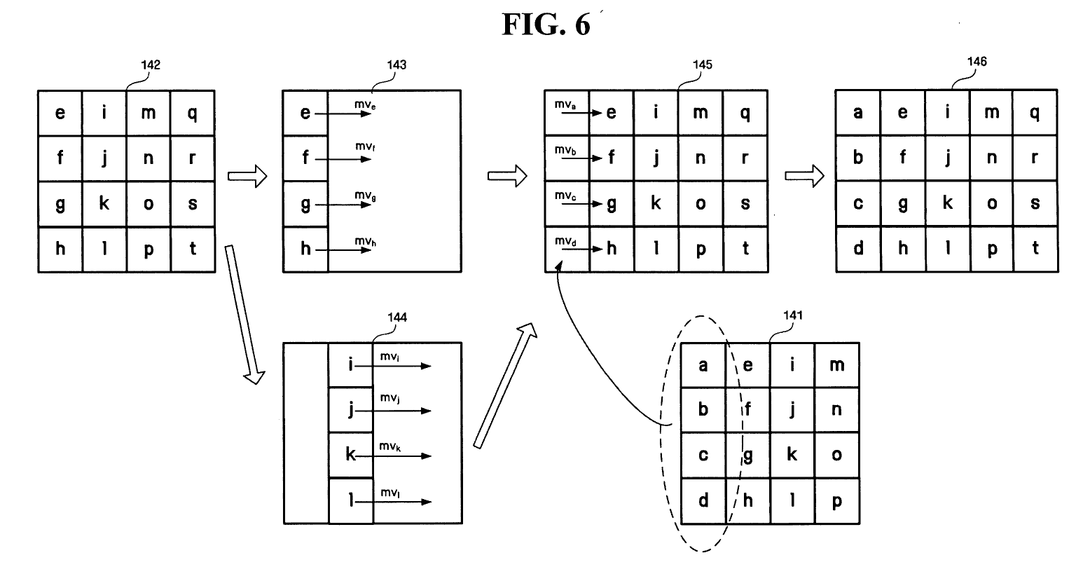

FIG. 6 is an example of generating a virtual area by proportionally calculating the motion information according to an embodiment of the present invention. If the motion information of the boundary area is different from the motion information of a neighboring area, the motion information may be calculated by a proportion between them to generate a virtual area from the previous frame. A frame 142 is provided as an example. Here, the motion vectors, i.e., the motion information of e, f, g and h are defined as mvₑ, mv_{f}, mv_{g} and mvₕ, respectively. The motion vectors of i, j, k and l existing in a right side of e, f, g and h are defined as mvᵢ, mvⱼ, mvₖ and mvₗ. The motion information of an area to be generated in a left side may be calculated by a proportion between the motion vectors. If the motion vectors of the area to be generated in the left side are defined as mvₐ, mv_{b}, mv_{c} and mv_{d} respectively, the rate between the motion vector of the boundary area block and the neighboring block may be calculated as follows:

$${mv}_{a} = {mv}_{e} \times \frac{{mv}_{e}}{{mv}_{i}} \qquad [ Equation 1 ]$$

And mv_{b}, mv_{c} and mv_{d} may be calculated by the same method described above. The motion vector of the frame 145 is calculated as described above, and a virtual area frame is generated by referring to the corresponding block in the frame 141 to include the virtual area.

Meanwhile, the motion information may be calculated by using the difference:
mvₐ=mvₑ−(mvᵢ−mvₑ) [Equation 2]

As shown in Equation 2, the motion information may be calculated by using the difference between the block e of the boundary area and the block i of the neighboring area. Here, Equation 2 may be adopted when the difference of the motion vectors are uniform in the respective blocks.

Alternatively, various methods may be used to generate the virtual area frame.

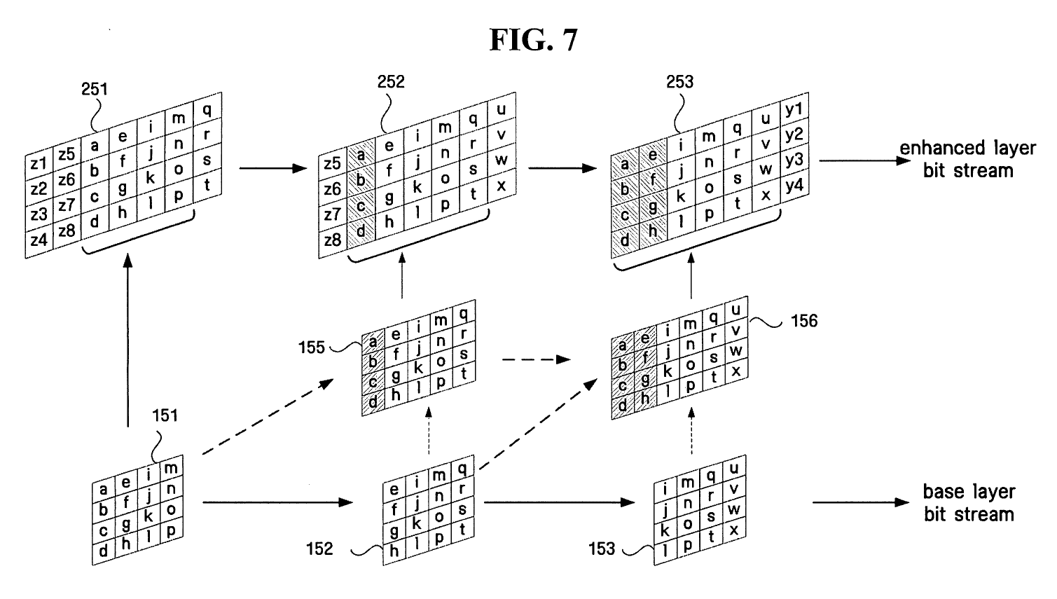

FIG. 7 is an example of generating a virtual area frame while it is encoded according to an embodiment of the present invention. Base layer frames 151, 152 and 153, upper layer frames 251, 252 and 253, and virtual area frames 155 and 156 are provided.

The frame 251 comprises 28 blocks from a block z1 to a block t. Sixteen blocks from a block a to a block p may refer to the base layers.

Meanwhile, the frame 252 comprises blocks z5 through x. The base frame of frame 252 is frame 152 comprising blocks e through t. A virtual area frame 155 may be generated by using the motion information of blocks e, f, g and h of frame 152. Thus, frame 252 may refer to 20 blocks of frame 155.

The base frame of the frame 253 is a frame 153 comprising blocks i through x. A virtual area frame 156 may be generated by using the motion information of blocks i, j, k and l of frame 153.

The motion information may be supplied by the previous virtual area frame 155. Then, a virtual area frame comprising 24 blocks may be referred to, thereby providing higher compression efficiency than the method that references frame 153 comprising 16 blocks. The virtual area frame may be predicted in the intra BL mode in order to enhance compression efficiency.

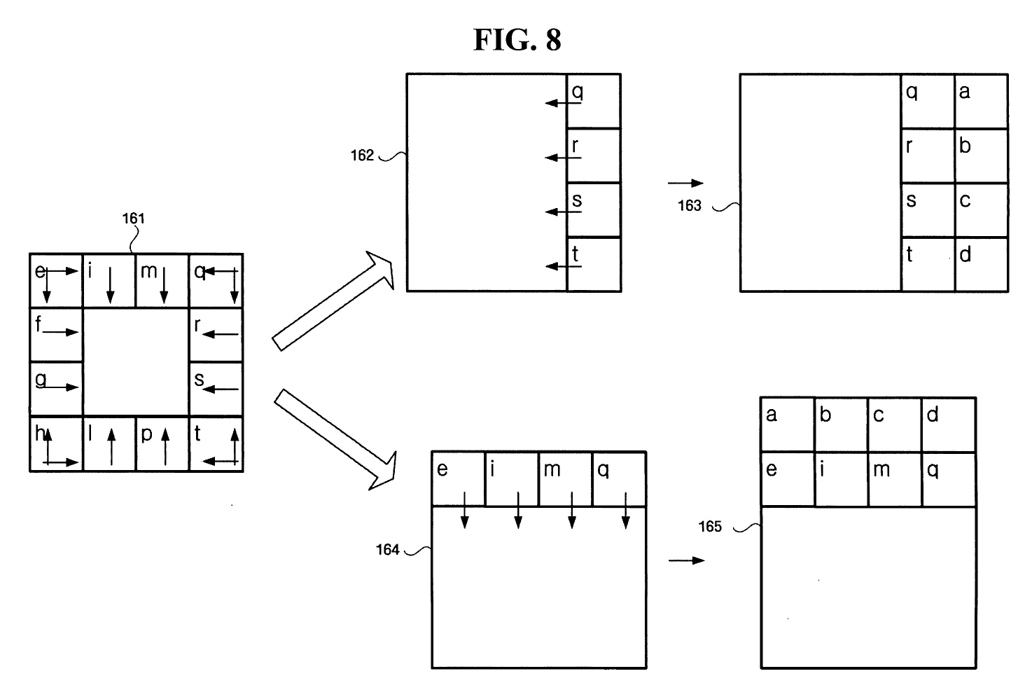

FIG. 8 is an example of generating the virtual area frame by using the motion information according to an embodiment of the present invention. The boundary area of the frame 161 may comprise up, down, left and right motion information. If far right blocks comprise motion information directed to a left side, the virtual area frame may be generated by referencing a right block of the previous frame. That is, the virtual area frame added with blocks a, b, c and d to the right side is generated like in the frame 163. The upper layer frame of the frame 162 may reference the frame 163 (to be coded).

Also, if top blocks of the frame 164 comprise motion information in a downward direction, the virtual area frame may be generated by referencing upper blocks in the previous frame. That is, blocks a, b, c and d are added to an upper part of the virtual area frame like in the frame 165. The upper layer frame of the frame 164 may reference the frame 165 (to be coded). Alternatively, an image in a diagonal direction may generate the virtual area frame through the motion information.

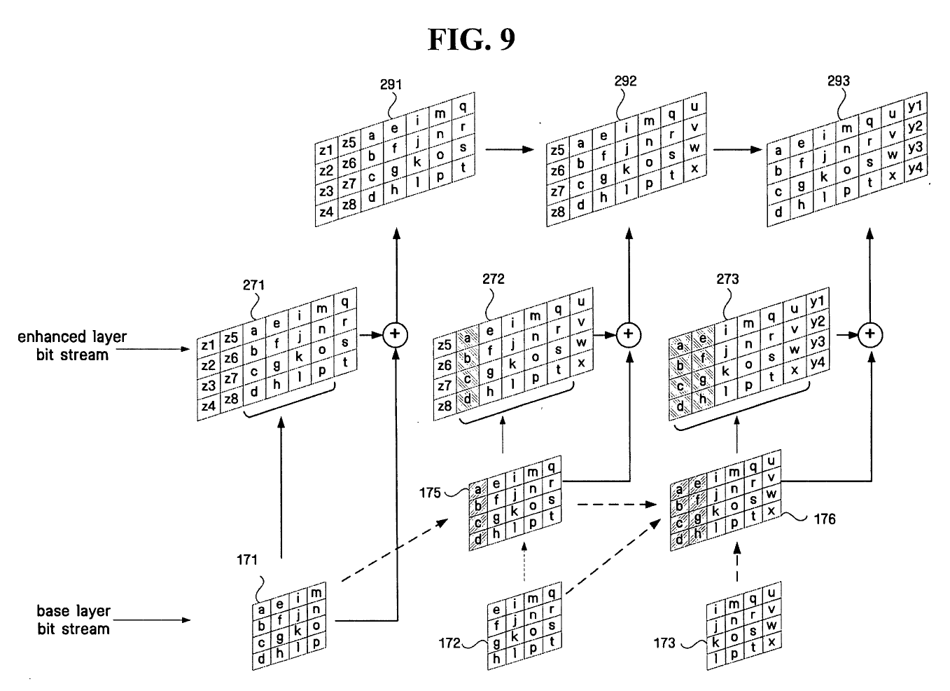

FIG. 9 is an example of decoding base and upper layers according to an embodiment of the present invention.

A bit stream that is supplied from data stored in networks or the storing medium is divided into a base layer bit stream and an enhanced layer bit stream to generate a scalable video. The base layer bit stream in FIG. 9 is in a 4:3 aspect ratio while the enhanced layer bit stream is in a 16:9 aspect ratio. The respective bit streams provide scalability according to size of the screen. A frame 291, to be output, is restored (decoded) from a frame 171 supplied through the base layer bit stream and from a frame 271 supplied from the enhanced layer bit stream. As parts a, b, c and d of the frame 272 are coded through the virtual area frame, a virtual area frame 175 is generated by the frame 172 and the previous frame 171. Also, a frame 292 is restored (decoded) from the frame 175 and the frame 272 to be output. As parts a, b, c, d, e, f, g and h of the frame 273 are coded through the virtual area frame, a virtual area frame 176 is generated by the frame 173 received by the base layer bit stream from the frame 175. A frame 293 is restored (decoded) by the frame 176 and the frame 273 to be output.

Terms “part”, “module” and “table” as used herein, mean, but are not limited to, software or hardware components, such as Field Programmable Gate Arrays (FPGAs) or Application Specific Integrated Circuits (ASICs), which perform certain tasks. A module may advantageously be configured to reside on an addressable storage medium and to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

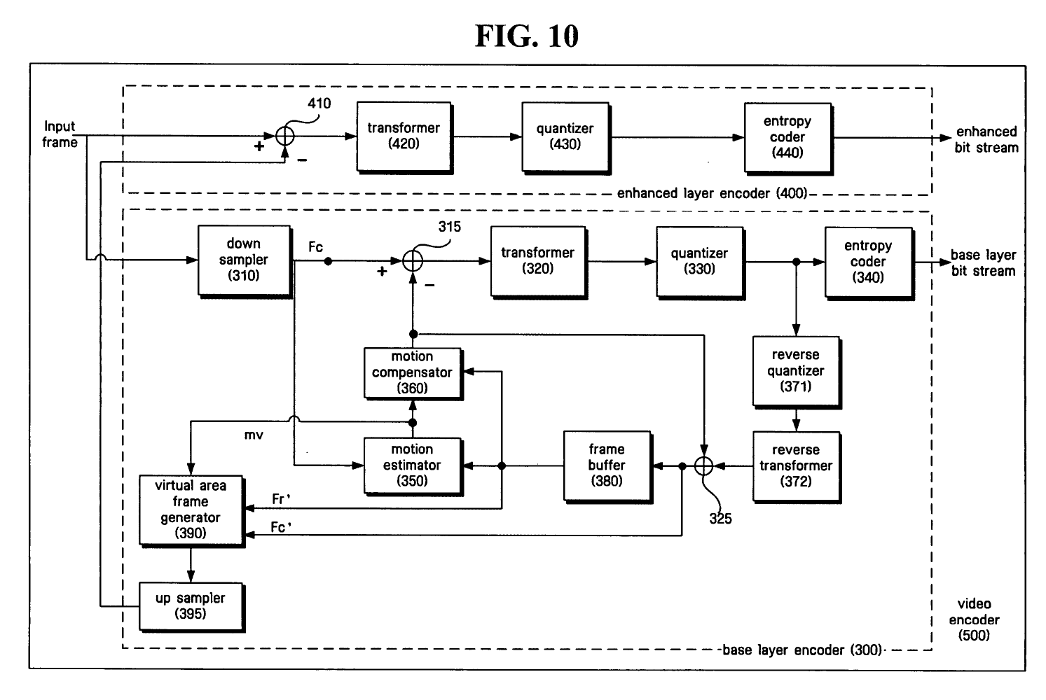

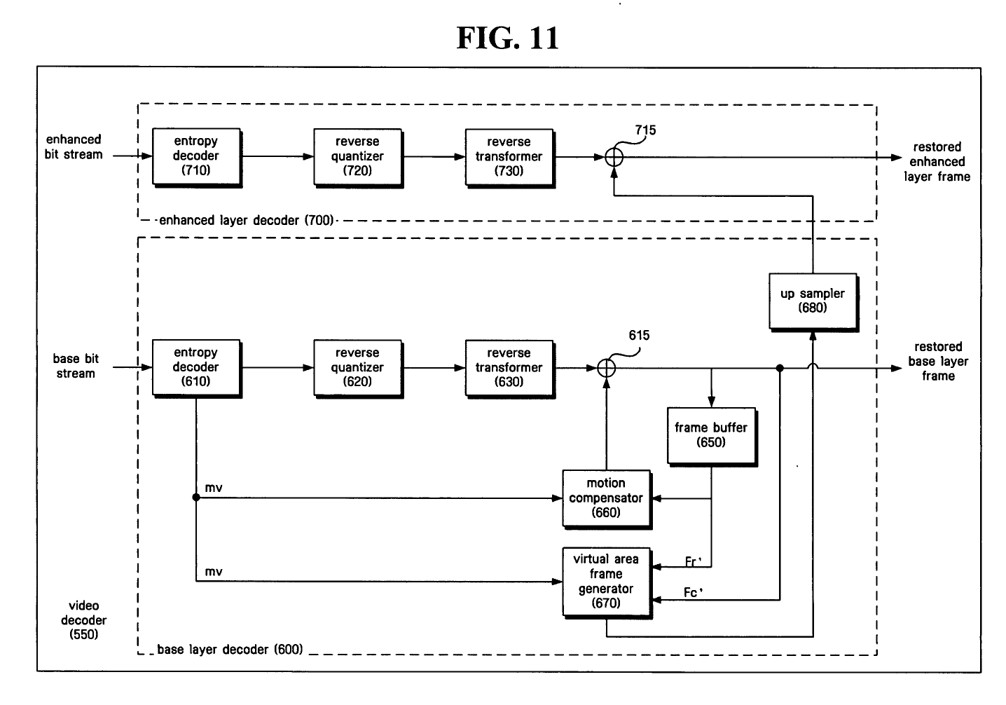

FIG. 10 is an example of a configuration of a video encoder according to an exemplary embodiment of the present invention. One base layer and one enhanced layer are provided and usage thereof is described with reference to FIGS. 10 and 11 by way of example, but the present invention is not limited thereto. Alternatively, the present invention may be applied to more layers.

A video encoder 500 may be divided into an enhanced layer encoder 400 and a base layer encoder 300. Hereinafter, a configuration of the base layer encoder 300 will be described.

A down sampler 310 down-samples an input video using a resolution and frame rate suitable for the base layer, or according to the size of the video. The down sampling may apply an MPEG down sampler or a wavelet down sampler for better resolution. The down sampling may be performed through frame skip or frame interpolation to produce a better frame rate. In the down sampling according to size of the video image, the video image originally input at the 16:9 aspect ratio is displayed at the 4:3 aspect ratio by excluding corresponding boundary areas from the video information or reducing the video information according to the corresponding screen size.

A motion estimator 350 estimates motions of the base layer frames to calculate motion vectors mv by partition, which is included in the base layer frames. The motion estimation is used to search an area in a reference frame Fr′ that is the most similar to respective partitions of a current frame Fc, i.e., the area with the least errors. The motion estimation may use fixed size block matching or layer variable size block matching. The reference frame Fr′ may be provided by a frame buffer 380. A base layer encoder 300, shown in FIG. 10, adopts a method of using the restored frame as the reference frame, i.e., closed loop coding, but the present invention is not limited thereto. Alternatively, the base layer encoder 300 may adopt open loop coding, which uses an original base layer frame supplied by the down sampler 310 as the reference frame.

Meanwhile, the motion vector mv of the motion estimator 350 is transmitted to a virtual area frame generator 390, thereby generating a virtual area frame added with a virtual area if the motion vector of the boundary area block of the current frame is directed to the center of the frame.

A motion compensator 360 uses the calculated motion vector to perform motion compensation on the reference frame. A differentiator 315 differentiates the current frame of the base layer and the motion-compensated reference frame to generate a residual frame.

A transformer 320 performs a spatial transform on the generated residual frame to generate a transform coefficient. The spatial transform comprises a discrete cosine transform, wavelet transform, etc. If the DCT is used, the transform coefficient refers to a DCT coefficient. If the wavelet transform is used, the transform coefficient refers to a wavelet coefficient.

A quantizer 330 quantizes the transform coefficient generated by the transformer 320. The term quantization refers to an operation in which the DCT coefficient is divided into predetermined areas according to a quantization table to be provided as a discrete value, and matched to a corresponding index. The quantized value is referred to as a quantized coefficient.

An entropy coder 340 lossless-codes the quantized coefficient generated by the quantizer 330 and the motion vector generated by the motion estimator 350 to generate the base layer bit stream. The lossless-coding may be Huffman coding, arithmetic coding, variable length coding, or another type of coding known in the art.

A reverse quantizer 371 reverse-quantizes the quantized coefficient output by the quantizer 330. The reverse-quantization restores a matching value from the index generated by the quantization through the quantization table used in the quantization.

A reverse transformer 372 performs a reverse spatial transform on the reverse-quantized value. The reverse spatial transform is performed in an opposite manner to the transforming process of the transformer 320. Specifically, the reverse spatial transform may be a reverse DCT transform, a reverse wavelet transform, or others.

A calculator 325 calculates an output value of the motion compensator 360, and an output value of the reverse transformer 372 to restore the current frame Fc,′ and to supply it to the frame buffer 380. The frame buffer 380 temporarily stores the restored frame therein and supplies it as the reference frame for the inter-prediction of other base layer frames.

A virtual area frame generator 390 generates the virtual area frame using the Fc′, which restores the current frame, the reference frame Fr′ of the current frame and the motion vector mv. If the motion vector mv of the boundary area block of the current frame is directed to the center of the frame as shown in FIG. 8, the screens moves. A virtual area frame is generated by copying a part of the blocks from the reference frame Fr′. The virtual area may be generated by copying the motion vectors as used in FIG. 5, or by the extrapolation through the proportion of motion vector values, as used in FIG. 6. If a virtual area is not generated, the current frame Fc′ may be selected to encode the enhanced layers, without adding the virtual areas. The frame extracted from the virtual area frame generator 390 is supplied to the enhanced layer encoder 400 through an upsampler 395. The upsampler 395 up-samples the resolution of the virtual base layer frame to that of the enhanced layer if the resolution of the enhanced layer is different from that of the base layer. If the resolution of the base layer is identical to that of the enhanced layer, the upsampling can be omitted. Also, if part of the video information of the base layer is excluded compared to the video information of the enhanced layer, the upsampling can be omitted.

Hereinafter, a configuration of the enhanced layer encoder 400 will be described. The frame supplied by the base layer encoder 300 and an input frame are supplied to the differentiator 410. The differentiator 410 differentiates the base layer frame comprising the input virtual area from the input frame to generate the residual frame. The residual frame is transformed into the enhanced layer bit stream through the transformer 420, quantizer 430 and the entropy coder 440, and is then output. Functions and operations of the transformer 420, the quantizer 430 and the entropy coder 440 are the same as those of the transformer 320, the quantizer 330 and the entropy coder 340. Thus, the description thereof is omitted.

The enhanced layer encoder 400 in FIG. 10 encodes the base layer frame added to the virtual area through the Intra-BL prediction. Also, the enhanced layer encoder 400 may encode the base layer frame added to the virtual area through inter-prediction or intra-prediction.

FIG. 11 is an example of a configuration of the video decoder according to an embodiment of the present invention. The video decoder 550 may be divided into an enhanced layer decoder 700 and a base layer decoder 600. Hereinafter, a configuration of the base layer decoder 600 will be described.

An entropy decoder 610 losslessly-decodes the base layer bit stream to extract texture data and motion data (i.e., motion vectors, partition information, and reference frame numbers) of the base layer frame.

A reverse quantizer 620 reverse-quantizes the texture data. The reverse quantization restores a matching value from the index generated by the quantization through the quantization table used in the quantization.

A reverse transformer 630 performs a reverse spatial transform on the reverse-quantized value to restore the residual frame. The reverse spatial transform is performed in an opposite manner to the transform of the transformer 320 in the video encoder 500. Specifically, the reverse transform may comprise the reverse DCT transform, the reverse wavelet transform, and others.

An entropy coder 610 supplies the motion data comprising the motion vector mv to the motion compensator 660 and the virtual area frame generator 670.

The motion compensator 660 uses the motion data supplied by the entropy coder 610 to motion-compensate the restored video frame, i.e., the reference frame, supplied by the frame buffer 650 and to generate the motion compensation frame.

A calculator 615 calculates the residual frame restored by the reverse transformer 630 and the motion compensation frame generated by the motion compensator 660 to restore the base layer video frame. The restored video frame may be temporarily stored in the frame buffer 650 or supplied to the motion compensator 660 or to the virtual frame generator 670 as the reference frame to restore other frames.

A virtual area frame generator 670 generates the virtual area frame with the Fc′ restoring the current frame, the reference frame Fr′ of the current frame and the motion vector mv. If the motion vector mv of the boundary area block of the current frame is directed to the center of the frame as shown in FIG. 8, the screens moves. A virtual area frame is generated by copying a part of blocks of the reference frame Fr′. The virtual area may be generated by copying the motion vectors as used in FIG. 5 or by extrapolation through calculating the proportional values of the motion vector values as used in FIG. 6. If no virtual area to generate is provided, the current frame Fc′ may be selected to decode the enhanced layers, without adding the virtual areas. The frame extracted from the virtual area frame generator 670 is supplied to the enhanced layer decoder 700 through an upsampler 680. The upsampler 680 up-samples the resolution of the virtual base layer frame to that of the enhanced layer if the resolution of the enhanced layer is different from that of the base layer. If the resolution of the base layer is identical to that of the enhanced layer, the upsampling can be omitted. If part of the video information of the base layer is excluded compared to the video information of the enhanced layer, the upsampling can be omitted.

Hereinafter, a configuration of the enhanced layer decoder 700 will be described. If the enhanced layer bit stream is supplied to the entropy coder 710, the entropy decoder 710 losslessly-decodes the input bit stream to extract texture data of an asynchronous frame.

The extracted texture data is restored as the residual frame through the reverse quantizer 720 and the reverse transformer 730. Functions and operations of the reverse transformer 720 and the reverse quantizer 730 are the same as those of the reverse transformer 620 and the reverse quantizer 630, respectively. Thus, the descriptions thereof are omitted.

A calculator 715 calculates the restored residual frame and the virtual area base layer frame supplied by the base layer decoder 600 to restore the frame.

The enhanced layer decoder 700 in FIG. 11 decodes the base layer frame added to the virtual area through the Intra-BL prediction, but the present invention is not limited thereto. Alternatively, the enhanced layer decoder 700 may decode the base layer frame added to the virtual area through the inter-prediction or the intra-prediction.

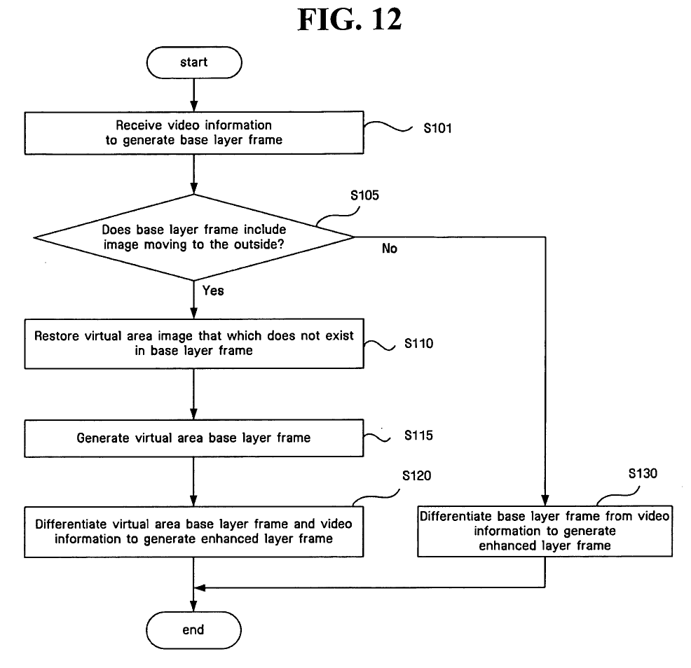

FIG. 12 is a flowchart showing the encoding of video according to an exemplary embodiment of the present invention. Video information is received to generate the base layer frame in operation S101. The base layer frame of the multi-layer frame may be down-sampled according to resolution, frame rate and size of the video images. If the size of the video is different by layer, for example, if the base layer frame provides an image in the 4:3 aspect ratio, and if the enhanced layer frame provides an image in the 16:9 aspect ratio, the base layer frame is encoded to the image with a part thereof excluded. As described in FIG. 10, the motion estimation, the motion compensation, the transform and the quantization are performed to encode the base layer frame.

The base layer frame generated in operation S101 detects whether the image is moving towards the outside in operation S105; this may be determined by the motion information in the boundary area of the base layer frame. If the motion vector of the motion information is directed toward the center of the frame, it is determined that the image moves towards the outside from the boundary area of the frame.

If the image is moving toward the outside of the frame from the boundary area, the virtual area image is restored by referencing the previous frame. The image moving toward the outside exists in the previous frame or in another previous frame. As shown in FIG. 10, the frame buffer 380 may store the previous frame or the frame added to the virtual area of the previous frame therein to restore the virtual area image in operation S110. The virtual area base layer frame adding the restored virtual area image to the base layer frame is generated in operation S110. The methods shown in FIG. 5 or 6 may be used. Then, the virtual area base layer frames 155 and 156 in FIG. 7 are generated. The enhanced layer frame is generated by the differentiation of the video information in operation S120. The enhanced layer frame is transmitted to the enhanced layer bit stream to be decoded by the decoder.

If the base layer frame does not comprise an image moving to the outside, the base layer frame is differentiated from the video information to generate the enhanced layer frame in operation S130.

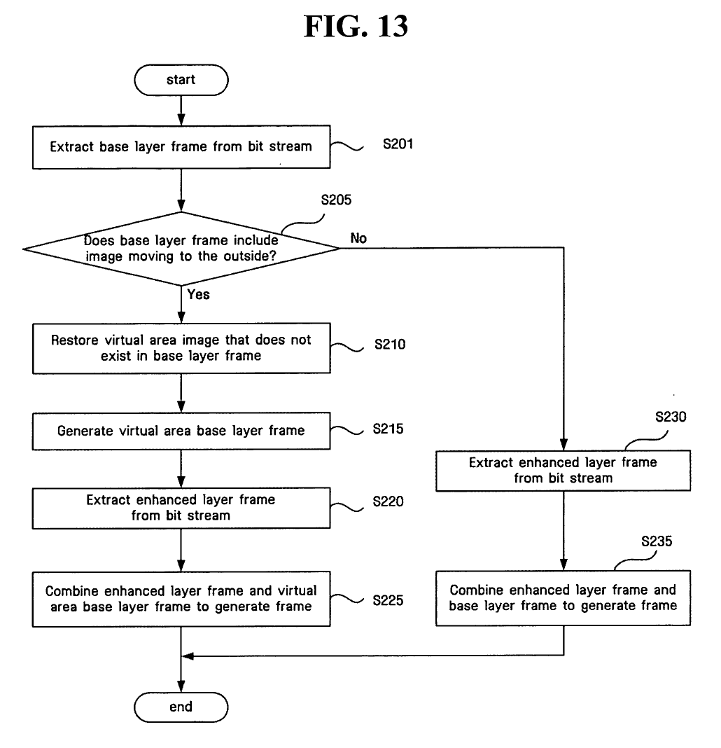

FIG. 13 is a flowchart showing the decoding of video according to an exemplary embodiment of the present invention. In operation S201 the base layer frame is extracted from the bit stream generated in FIG. 12. The coding, the reverse quantization and reverse transform are performed while extracting the base layer frame. It is detected whether the extracted base layer frame comprises an image moving toward the outside in operation S205. It may be determined by the motion information of the blocks in the boundary area of the base layer frame. If the motion vectors of the boundary area blocks are directed toward the center or the inside of the frame, a part or all of the image is moving toward the outside of the frame compared to the previous frame. Accordingly, the virtual area image that does not exist in the base layer frame is restored through the previous frame or another previous frame in operation S210. The virtual area base layer frame adding the virtual area image to the base layer frame is generated in operation S215. Frames 175 and 176 in FIG. 9 are examples of the virtual area base layer frame. The enhanced layer frame is extracted from the bit stream in operation S220. The enhanced layer frame and the virtual area base layer frame are combined to generate a frame in operation S225.

If the base layer frame does not comprise an image moving toward the outside in operation S205, the enhanced layer frame is extracted from the bit stream in operation S230. The enhanced layer frame and the base layer frame are combined to generate the frame in operation S235.

It will be understood by those of ordinary skill in the art that various changes in form and details may be made therein without departing from the spirit and scope of the present invention as defined by the following claims. Therefore, the scope of the invention is given by the appended claims, rather than by the preceding description, and all variations and equivalents which fall within the range of the claims are intended to be embraced therein.

According to the present invention, it is possible to encode and decode an upper layer video through motion information while coding a video in a multi-layer structure having layers with variable sizes.

In addition, according to the present invention, it is possible to restore an image that is not included in a base frame through motion information and to improve the compression efficiency.

What is claimed is:

1. A method for encoding and referencing a virtual area image, the method comprising:
(a) generating a base layer frame from an input video signal;
(b) restoring a virtual area image in an outside area of the base layer frame through a corresponding image of a reference frame of the base layer frame;
(c) adding the restored virtual area image to the base layer frame to generate a virtual area base layer frame; and
(d) differentiating the virtual area base layer frame from the video signal to generate an enhanced layer frame.

2. The method of claim 1, wherein (b) comprises determining the virtual area image in the outside area of the base layer frame as a motion vector of a block existing in a boundary area of the base layer frame.

3. The method of claim 1, wherein the reference frame of (b) is ahead of the base layer frame.

4. The method of claim 1, wherein (b) comprises copying motion information that exists in the boundary area of the base layer frame.

5. The method of claim 1, wherein (b) comprises generating motion information according to a proportion of motion information of the block in the boundary area of the base layer frame and motion information of a neighboring block.

6. The method of claim 1, wherein the enhanced layer frame of (d) comprises an image having a larger area than the image supplied by the base layer frame.

7. The method of claim 1, further comprising storing the virtual area base layer frame of the base layer frame.

8. A method for decoding and referencing a virtual area image comprising:
(a) restoring a base layer frame from a bit stream;
(b) restoring a virtual area image in an outside area of the restored base layer frame through a corresponding image of a reference frame of the base layer frame;
(c) adding the restored virtual area image to the base layer frame to generate a virtual area base layer frame;
(d) restoring an enhanced layer frame from the bit stream; and
(e) combining the enhanced layer frame and the virtual area base layer frame to generate an image.

9. The method of claim 8, wherein (b) comprises determining the virtual area image in the outside area of the base layer frame as a motion vector of a block that exists in a boundary area of the base layer frame.

10. The method of claim 8, wherein the reference frame of (b) is ahead of the base layer frame.

11. The method of claim 8, wherein (b) comprises copying motion information that exists in the boundary area of the base layer frame.

12. The method of claim 8, wherein (b) comprises generating motion information according to a proportion of motion information of a block in a boundary area of the base layer frame and motion information of a neighboring block.

13. The method of claim 8, wherein the enhanced layer frame of (e) comprises an image having a larger area than the image supplied by the base layer frame.

14. The method of claim 8, further comprising storing the virtual area base layer frame or the base layer frame.

15. An encoder comprising:
a base layer encoder configured to generate a base layer frame from an input video signal; and
an enhanced layer encoder configured to generate an enhanced layer frame from the video signal,
wherein the base layer encoder restores a virtual area image in an area outside of the base layer frame through a corresponding image of a reference frame of the base layer frame and adds the restored virtual area image to the base layer frame to generate a virtual area base layer frame, and the enhanced layer encoder differentiates the virtual area base layer frame from the video signal to generate an enhanced layer frame.

16. The encoder of claim 15, further comprising a motion estimator configured to acquire motion information of an image and to determine the virtual area image in the outside area of the base layer frame as a motion vector of a block that exists in a boundary area of the base layer frame.

17. The encoder of claim 15, wherein the reference frame is ahead of the base layer frame.

18. The encoder of claim 15, wherein the base layer encoder comprises a virtual area frame generator configured to copy motion information that exists in the boundary area of the base layer frame.

19. The encoder of claim 15, wherein the base layer encoder comprises a virtual area frame generator configured to generate motion information according to a proportion of motion information of a block existing in the boundary area of the base layer frame and motion information of a neighboring block.

20. The encoder of claim 15, wherein the enhanced layer frame comprises an image having a larger area than the image supplied by the base layer frame.

21. The encoder of claim 15, further comprising a frame buffer to store the virtual area base layer frame or the base layer frame therein.

22. A decoder comprising:
a base layer decoder configured to restore a base layer frame from a bit stream; and
an enhanced layer decoder configured to restore an enhanced layer frame from the bit stream,
wherein the base layer decoder comprises a virtual area frame generator configured to generate a virtual area base layer frame by restoring a virtual area image in an outside area of the restored base layer frame through a corresponding image of a reference frame of the base layer frame by adding the restored image to the base layer frame, and the enhanced layer decoder combines the enhanced layer frame and the virtual area base layer frame to generate an image.

23. The decoder of claim 22, further comprising a motion estimator configured to acquire motion information of an image and to determine the virtual area image in the outside area of the base layer frame as a motion vector of a block that exists in a boundary area of the base layer frame.

24. The decoder of claim 22, wherein the reference frame is ahead of the base layer frame.

25. The decoder of claim 22, wherein base layer decoder comprises a virtual area frame generator configured to copy motion information that exists in the boundary area of the base layer frame.

26. The decoder of claim 22, wherein the base layer decoder comprises a virtual area frame generator configured to generate motion information according to a proportion of motion information of a block existing in the boundary area of the base layer frame and motion information of a neighboring block.

27. The decoder of claim 22, wherein the enhanced layer frame comprises an image having a larger area than the image supplied by the base layer frame.

28. The decoder of claim 22, further comprising a frame buffer to store the virtual area base layer frame or the base layer frame therein.
